(19) United States
(12) Patent Application Publication
(10) Pub. No.: US 2025/0147857 A1
(43) Pub. Date: May 8, 2025

(54) INTERMITTENT SYSTEM AND METHOD OF DRIVING THE SAME

(71) Applicant: ELECTRONICS AND TELECOMMUNICATIONS RESEARCH INSTITUTE, Daejeon (KR)

(72) Inventors: Youngbin KIM, Daejeon (KR); Kwang Yong LEE, Daejeon (KR); Yoojin LIM, Daejeon (KR); Chae Deok LIM, Daejeon (KR); Jung Eun CHA, Daejeon (KR)

(21) Appl. No.: 18/937,414

(22) Filed: Nov. 5, 2024

(30) Foreign Application Priority Data
Nov. 7, 2023 (KR) 10-2023-0152956

(51) Int. Cl. G06F 11/30; G06F 11/14; G06F 12/02; H02J 50/00

(52) U.S. Cl. CPC G06F 11/3058; G06F 11/1441; G06F 12/0238; H02J 50/001

(57) ABSTRACT

Provided is a method of driving an intermittent system, which includes: generating a reference code and a transition code in which a power polling function is added to the reference code, and storing the reference code and the transition code in a memory; executing the reference code; storing storage information including an instruction address of the reference code that is in execution when a power interrupt is received, and calculating an instruction address of the transition code corresponding to the instruction address of the reference code; executing the transition code from the calculated instruction address of the transition code; and performing the power polling added to the transition code.

### CROSS-REFERENCE TO RELATED APPLICATION

This application claims priority to and the benefit of Korean Patent Application No. 10-2023-0152956, filed on Nov. 7, 2023, the disclosure of which is incorporated herein by reference in its entirety.

### BACKGROUND

### 1. Field of the Invention

The present disclosure generally relates to an intermittent system and a method of driving the same.

### 2. Discussion of Related Art

In a computer system, methods of obtaining event occurrence information of external devices other than a central processing unit (CPU) and a memory may be largely divided into polling and interrupt. Polling is a method in which the CPU proactively checks the statuses of external devices to monitor an occurrence of an event while interrupt is a method in which external devices transmit signals to the CPU when an event occurs.

An intermittent system is a system for operating small Internet of Things (IoT) devices or wearable devices without using a battery, and includes an energy harvesting device and a small capacitor. These devices collect energy from the environment through energy harvesting and store the collected energy in the capacitor, and intermittently perform computing when sufficient energy is collected.

### SUMMARY OF THE INVENTION

The intermittent system monitors the voltage of the capacitor. When the voltage charged in the capacitor falls to a certain value or less, the intermittent system expects that the power of the system may soon be cut off, and performs a checkpoint operation of storing the current state of the system in a nonvolatile memory. The checkpoint operation may be performed after storing one or more of a program counter (PC) value, data stored in a register, and/or data stored in a stack.

Methods of monitoring the voltage charged in the capacitor include the polling method and the interrupt method that were described above. The polling method has a limitation in that when a polling code is inserted, the overhead from the polling itself is large, and pre-optimization through a compiler is difficult with the interrupt method because there is a chance of a checkpoint being performed at any location during the execution of the application program.

The present disclosure aims to resolve the issues described above.

According to an aspect of the present invention, there is provided a method of driving an intermittent system, which includes: generating a reference code and a transition code in which a power polling function is added to the reference code, and storing the reference code and the transition code in a memory; executing the reference code; storing storage information including an instruction address of the reference code that is in execution when a power interrupt is received, and calculating an instruction address of the transition code corresponding to the instruction address of the reference code; executing the transition code from the calculated instruction address of the transition code; and performing the power polling added to the transition code.

According to another aspect of the present invention, there is provided an intermittent system including a processor and a memory that is accessed by the processor and stores instructions that, when executed by the processor, cause the intermittent system to perform a method, the method including: generating a reference code and a transition code in which a power polling function is added to the reference code, and storing the reference code and the transition code in the memory; executing the reference code; storing storage information including an instruction address of the reference code that is in execution when a power interrupt is received, and calculating an instruction address of the transition code corresponding to the instruction address of the reference code; executing the transition code from the calculated instruction address of the transition code; and performing the power polling added to the transition code.

The intermittent system may be a system that operates without a battery after storing energy collected through energy harvesting in a capacitor.

The transition code may further include a check point function for storing a current program counter, register data, and data, which is stored in a stack, in the reference code.

The storage information and a current program counter, register data, and data stored in a stack may be stored in a nonvolatile memory.

The intermittent system may manage power in an interrupt mode before receiving the power interrupt, and may manage power in a polling mode after receiving the power interrupt.

The method may further include, after the executing of the transition code, performing the power polling added to the transition code.

The method may further include, after the performing of the power polling, shutting down the intermittent system when operating power is insufficient.

The method may further include: when power is restored after the shutting down of the intermittent system, calculating an instruction address of the reference code corresponding to the stored instruction address of the transition code; and executing the reference code from the calculated instruction address of the reference code.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic flowchart showing a method of driving an intermittent system according to the present embodiment;

FIG. 2 is a schematic view illustrating an intermittent system according to the present embodiment;

FIG. 3 is a schematic view illustrating a memory according to the present embodiment;

FIG. 4 is an exemplary view illustrating a code transition when a processor receives a power interrupt; and

FIG. 5 is a schematic view illustrating a state in which an intermittent system has recovered after being shut down.

### DETAILED DESCRIPTION OF EXEMPLARY EMBODIMENTS

Hereinafter, the present embodiments will be described with reference to the accompanying drawings.

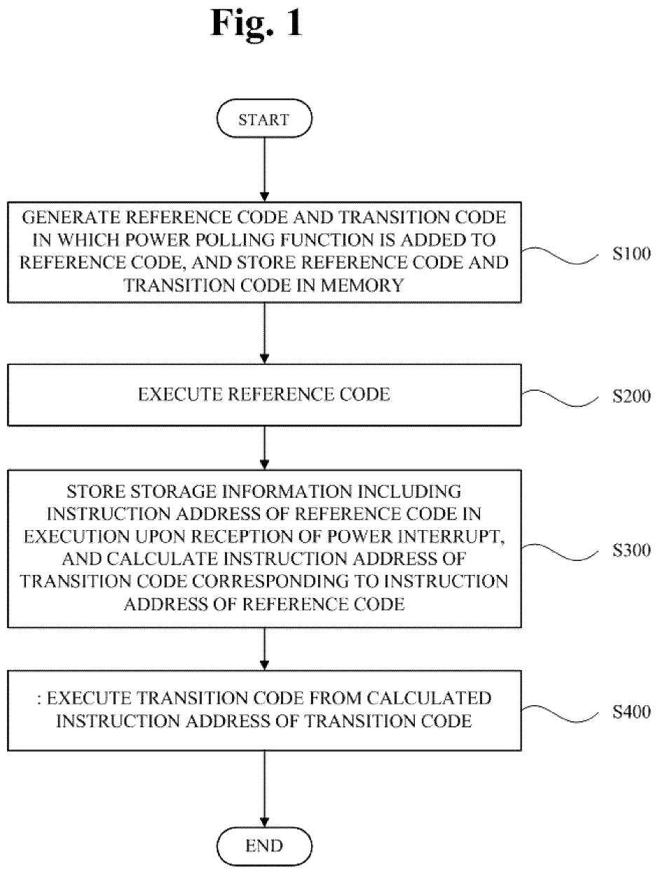

FIG. 1 is a schematic flowchart showing a method of driving an intermittent system according to the present embodiment. Referring to FIG. 1, the method of driving an intermittent system according to the present embodiment includes: generating a reference code and a transition code in which a power polling function is added to the reference code, and storing the reference code and the transition code in a memory (S100); executing the reference code (S200); storing storage information including an instruction address of the reference code that is in execution when a power interrupt is received, and calculating an instruction address of the transition code corresponding to the instruction address of the reference code (S300); and executing the transition code from the calculated instruction address of the transition code (S400).

In one embodiment, subsequent to the executing of the transition code (S400), performing the power polling added to the transition code may be further included.

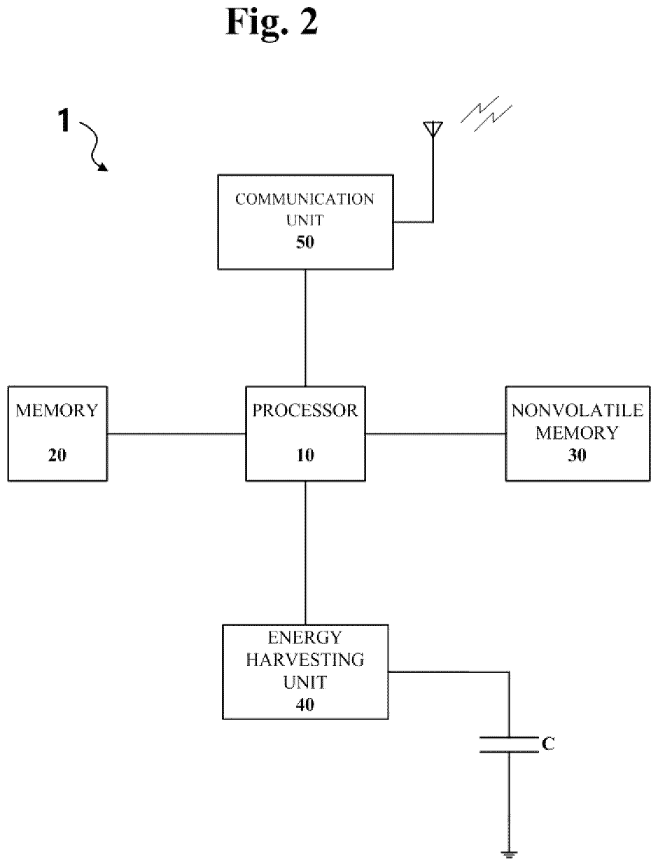

FIG. 2 is a schematic view illustrating an intermittent system 1 according to an embodiment. The intermittent system 1 according to the present embodiment may include: a processor 10 and a memory 20 that is accessed by the processor 10 and stores instructions that, when executed by the processor 10, cause the intermittent system to perform a method, and the method includes: generating a reference code and a transition code in which a power polling function is added to the reference code, and storing the reference code and the transition code in the memory (S100); executing the reference code (S200); storing storage information including an instruction address of the reference code in execution when a power interrupt is received, and calculating an instruction address of the transition code corresponding to the instruction address of the reference code (S300); and executing the transition code from the calculated instruction address of the transition code (S400).

In one embodiment, subsequent to the executing of the transition code (S400), performing the power polling added to the transition code may be further included.

Referring to FIG. 2, the intermittent system 1 according to the present embodiment includes a processor 10, a memory 20, a nonvolatile memory 30, an energy harvesting unit 40, and a communication unit 50. The intermittent system 1 shown in FIG. 2 is based on one embodiment, and not all blocks illustrated in FIG. 2 are required components, and some blocks may be added, changed, or omitted from the intermittent system 1 in other embodiments. Meanwhile, the intermittent system 1 may be implemented as a computing device, and each component included in the intermittent system 1 may be implemented as a separate software device, or may be implemented as a separate hardware device combined with software.

Although not shown in FIG. 2, the intermittent system 1 may further include a measuring device (not shown). The measuring device (not illustrated) may be, for example, a temperature sensor or a humidity sensor that measures external temperature, humidity, or the like, and the intermittent system may provide the temperature measured by the measuring device to the outside through the communication unit 50. In addition, the measuring device (not shown) may be, for example, a gas sensor that measures the concentration of harmful flammable gases such as carbon monoxide, propane, and the like in an environment in which the measuring device is placed, and the intermittent system may provide the presence and/or concentration of the gas measured by the measuring device to the outside through the communication unit 50.

The communication unit 50 may provide data provided by the intermittent system 1 to the outside through wired and/or wireless communication in connection with the processor 10. The communication unit 50 may intermittently transmit data to the outside through a wireless data protocol of Bluetooth or ZigBee.

The processor 10 executes at least one instruction or program included in the memory 20. The processor 10 according to the present embodiment calculates data for performing each operation based on data obtained from the measuring device (not shown) and/or the memory 20.

The memory 20 stores one or more instructions that, when executed by the processor 10, cause the method of driving the intermittent system described above to be performed. In one embodiment, the memory 20 stores a reference code and a transition code in which a power polling function is added to the reference code. In addition, the memory 20 may store related values, such as results of performing each operation, intermediate values, and the like.

The nonvolatile memory 30 stores one or more of a PC value, data stored in a register, and/or data stored in a stack when the intermittent system 1 performs a checkpoint operation or is shut down. For example, when the intermittent system 1 is restarted after a checkpoint operation or shutdown due to a power shortage, the processor 10 may be restarted by referring to one or more of the PC value, the data stored in the register, and/or the data stored in the stack that are stored in the nonvolatile memory 30.

The energy harvesting unit 40 collects energy for the intermittent system 1 to operate, and stores the collected energy in an energy storage element. In the illustrated embodiment, the energy collected by the energy harvesting unit 40 may be charged in the form of a voltage in a capacitor C. In addition, the energy harvesting unit 40 may include at least one of a solar panel that collects energy from sunlight provided at a deployment location, a radio frequency (RF) energy collection device that collects radio waves at a deployment location and stores energy, a device that collects energy from a piezoelectric effect, and a device that collects energy from a thermoelectric effect.

In one embodiment, the energy harvesting unit 40 may provide an interrupt to the processor 10 when the magnitude of the voltage charged in the capacitor C falls below a threshold value. In addition, the processor 10 may monitor the magnitude of the voltage charged in the capacitor C in a polling mode and perform a checkpoint operation when the magnitude of the voltage charged in the capacitor C falls below the threshold value.

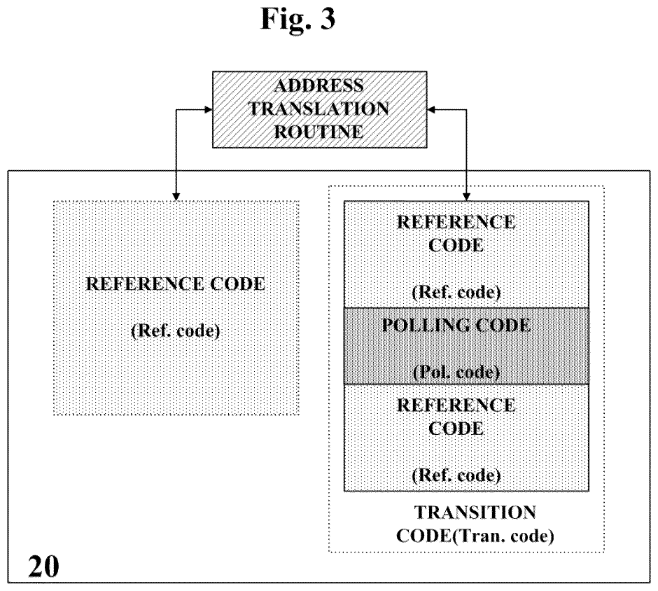

FIG. 3 is a schematic view illustrating a memory 20 according to the present embodiment. Referring to FIGS. 1 to 3, a reference code (Ref. code) and a transition code in which a polling code (Pol. code) that performs a power polling function is added to the reference code (Ref. code) are generated, and the reference code (Ref. code) and the transition code are stored in the memory 20 (S100).

In one embodiment, the reference code (Ref. code) is a general computer program, which is a code of program written in a high-level language, translated by a compiler and then converted into a binary code to be executable by the processor 10. The reference code (Ref. code) drives the processor 10 and the like such that the intermittent system 1 performs intended operations. For example, when the intermittent system 1 is a temperature sensor, the reference code (Ref. code) may be a code that causes a measuring device (not shown) to measure the temperature at the current location, convert the measured temperature into data in a predetermined format, and transmit the data to the outside through the communication unit 50. When the intermittent system 1 operates with the reference code (Ref. code), the processor 10 may receive an alert of the power stored in the capacitor C in an interrupt mode.

The transition code is a code in which a polling code (Pol. code) is added to the reference code (Ref. code). The transition code (Tran. code) is a code that performs the same operation as the reference code, but to which a function of checking the voltage of the capacitor C that stores energy, and when needed, performing a checkpoint operation is added.

The polling code (Pol. code) may be inserted in a location directly set by a programmer or inserted in an appropriate location through analysis during compilation, to reduce system overhead and power consumption. In general, when performing an interrupt-based checkpoint operation, only the reference code is used, and when using a polling-type checkpoint, only the additional polling code is used, but the present embodiment is configured to generate both codes and store the codes in the memory 20.

An address translation routine is a routine configured to handle address translation between the reference code (Ref. code) and the transition code (Tran. code). For example, the address translation routine may be configured in various methods, such as being configured as a table or calculated upon request by an algorithm. Since the transition code (Tran. code) is a copy of the reference code (Ref. code) with a polling code added thereto, the transition code (Tran. code) has the same instructions corresponding to each instruction of the reference code (Ref. code).

The address translation routine provides a function of mapping the instruction in the reference code (Ref. code) to the corresponding instruction in the transition code (Tran. code) to enable bidirectional translation. In general, a checkpoint request code may be implemented as a one-line system call instruction that does not use a register, in which case the address translation device may be implemented using a small space.

The intermittent system 1 executes the reference code (Ref. code) (S200) to perform the intended operation when the power collected by the energy harvesting unit 40 and charged into the capacitor C is greater than a threshold value. When the power charged in the capacitor C decreases below the threshold, the energy harvesting unit 40 detects the decrease in the power and outputs an interrupt to the processor 10.

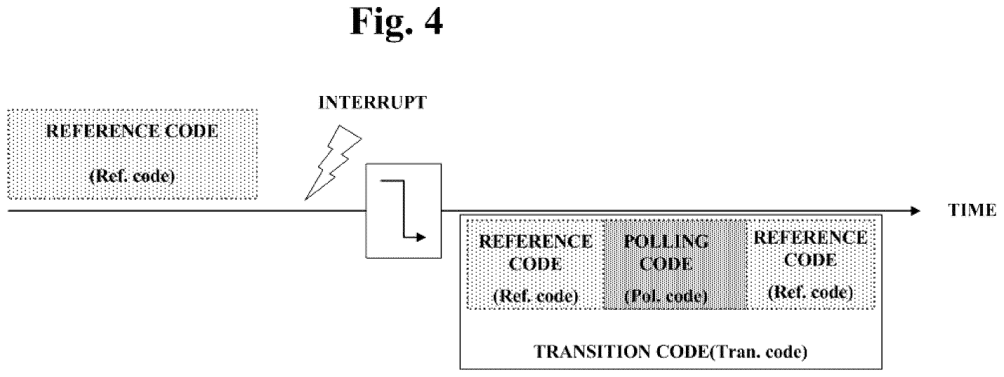

FIG. 4 is an exemplary view illustrating a code transition when a processor 10 receives a power interrupt. Referring to FIG. 4, the processor 10 stores storage information including an instruction address of the reference code in execution when a power interrupt is received, and calculates an instruction address of the transition code corresponding to the instruction address of the reference code (S300).

When the voltage of the capacitor C is sufficient, the reference code (Ref. code) without a load due to polling operates. However, when the voltage charged in the capacitor C decreases below a threshold value, the processor 10 receives an interrupt signal. When an interrupt occurs, an application program in execution temporarily stores the values of the registers on the stack, and registers, such as a program counter PC indicating the address of the next instruction to be executed by the application, and a link register storing addresses according to the instruction architecture, also undergo a stacking process, and then executes an interrupt service routine (ISR).

In the present embodiment, the ISR performs address translation from the reference code (Ref. code) to the corresponding transition code (Tran. code), and changes the stacked register values, thereby allowing the application to resume from the transition code (Tran. code) instead of the reference code (Ref. code) (S400). When the ISR ends after the address translation is completed, the program may resume execution from the transition code (Tran. code) according to the changed PC and perform an optimized checkpoint operation.

In one embodiment, when an ISR is performed, the processor 10 may monitor the voltage by performing polling on the voltage of the capacitor C included in the transition code (Tran. code) after performing a checkpoint operation. In addition, when the energy charged in the capacitor C decreases below a threshold value, and the energy harvesting unit 40 is unable to continuously charge power to the capacitor C, the intermittent system 1 may be shut down.

The energy harvesting unit 40 collects energy and charges the energy to the capacitor C, a voltage higher than or equal to a set threshold value may be formed in the capacitor C by the charged energy, and the intermittent system 1 is recovered.

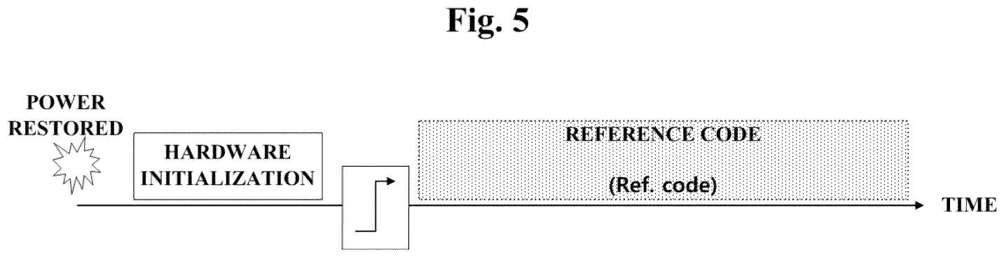

FIG. 5 is a schematic view illustrating a state in which an intermittent system has recovered after being shut down. Referring to FIGS. 1 to 5, a recovery process, which is a process in which power is cut off after the shutdown and then sufficient energy is secured again to recover the system, is shown. When power is secured again, a system kernel performs basic hardware initialization and then restores the state of the program from the stored checkpoint. In this case, since the checkpoint has been performed on the polling-added code, when the system is recovered (recovery), an address translation process is performed such that the program may resume with the reference code (Ref. code) based on the registers and data holding the address again. When the recovery is completed after the address translation, the program may resume execution from the reference code (Ref. code) without polling overhead.

In the present embodiment, the conversion of the PC, which is essential to the address translation operation, has been described, but additional management methods or conversions may be required depending on the system architecture, compilation method, and programming language. For example, during application execution, a general register or a specific memory address other than a PC may have an instruction address, and in this case, additional checks may be performed during compilation such that conversion to the corresponding data may be performed at the address translation operation, or additional compiler/runtime support may be required, such as tracking the register or memory address that is the target of the address translation at runtime.

In addition, although the configuration of the present embodiment assumes an interrupt by an external voltage monitor as an example, the configuration of the present invention may be applied to other types of interrupts. For example, in a system without an external voltage monitor, a timer interrupt may be used such that the system operates for most of the time with a reference code (Ref. code) and then switches to a transition code after a specific period of time to perform a check point.

As is apparent from the above, the intermittent system according to the present embodiment can switch between a polling mode and an interrupt mode at runtime. This allows the system to simultaneously benefit from the efficiency that can be obtained from the interrupt mode and the effects of compiler optimization applicable to the polling mode, which enables faster and more energy-efficient application execution at a low cost using code storage memory that is a relatively abundant resource.

Specific embodiments are shown by way of example in the specification and the accompanying drawings and are merely intended to aid in the explanation and understanding of the technical spirit of the present invention rather than limiting the scope of the present invention. Those of ordinary skill in the technical field to which the present invention pertains should be able to understand that various modifications and alterations may be made without departing from the technical spirit or essential features of the present invention. Therefore, the scope of the present invention is defined by the appended claims rather than by the foregoing description.

What is claimed is:

1. A method of driving an intermittent system, the method comprising:
generating a reference code and a transition code in which a power polling function is added to the reference code, and storing the reference code and the transition code in a memory;
executing the reference code;
storing storage information including an instruction address of the reference code that is in execution when a power interrupt is received, and calculating an instruction address of the transition code corresponding to the instruction address of the reference code;
executing the transition code from the calculated instruction address of the transition code; and
performing the power polling added to the transition code.

2. The method of claim 1, wherein the intermittent system is a system that operates without a battery after storing energy collected through energy harvesting in a capacitor.

3. The method of claim 1, wherein the transition code further includes a check point function for storing a current program counter, register data, and data, which is stored in a stack, in the reference code.

4. The method of claim 1, wherein the storage information and a current program counter, register data, and data stored in a stack are stored in a nonvolatile memory.

5. The method of claim 1, wherein the intermittent system manages power in an interrupt mode before receiving the power interrupt, and manages power in a polling mode after receiving the power interrupt.

6. The method of claim 1, further comprising, after the executing of the transition code, performing the power polling added to the transition code.

7. The method of claim 1, further comprising, after the performing of the power polling, shutting down the intermittent system when operating power is insufficient.

8. The method of claim 7, further comprising:
when power is restored after the shutting down of the intermittent system, calculating an instruction address of the reference code corresponding to the stored instruction address of the transition code; and
executing the reference code from the calculated instruction address of the reference code.

9. An intermittent system comprising a processor and a memory that is accessed by the processor and stores instructions that, when executed by the processor, cause the intermittent system to perform a method, the method comprising:
generating a reference code and a transition code in which a power polling function is added to the reference code, and storing the reference code and the transition code in the memory;
executing the reference code;
storing storage information including an instruction address of the reference code that is in execution when a power interrupt is received, and calculating an instruction address of the transition code corresponding to the instruction address of the reference code;
executing the transition code from the calculated instruction address of the transition code; and
performing the power polling added to the transition code.

10. The intermittent system of claim 9, wherein the intermittent system is a system that operates without a battery after storing energy collected through energy harvesting in a capacitor.

11. The intermittent system of claim 9, wherein the transition code further includes a check point function for storing a current program counter, register data, and data, which is stored in a stack, in the reference code.

12. The intermittent system of claim 9, wherein the storage information and a current program counter, register data, and data stored in a stack are stored in a nonvolatile memory.

13. The intermittent system of claim 9, wherein the intermittent system manages power in an interrupt mode before receiving the power interrupt, and manages power in a polling mode after receiving the power interrupt.

14. The intermittent system of claim 9, wherein the method further comprises, after the executing of the transition code, performing the power polling added to the transition code.

15. The intermittent system of claim 9, wherein the method further comprises, after the performing of the power polling, shutting down the intermittent system when operating power is insufficient.

16. The intermittent system of claim 15, wherein the method further comprises:
when power is restored after the shutting down of the intermittent system, calculating an instruction address of the reference code corresponding to the stored instruction address of the transition code; and
executing the reference code from the calculated instruction address of the reference code.
